(19) United States
(12) Patent Application Publication
(10) Pub. No.: US 2022/0242166 A1
(43) Pub. Date: Aug. 4, 2022

(54) Multi-Part Railway Wheel for a Railway Vehicle

(71) Applicant: Bochumer Verein Verkehrstechnik GmbH, Bochum (DE)

(72) Inventor: Franz Murawa, Bochum (DE)

(21) Appl. No.: 17/612,837

(22) PCT Filed: May 19, 2020
(86) PCT No.: PCT/EP2020/063939

§ 371 Date: Nov. 19, 2021

(30) Foreign Application Priority Data
May 22, 2019 (DE) 10 2019 113 624.5

(51) Int. Cl. B60B 17/00; B60B 9/16

(52) U.S. Cl. CPC B60B 17/0034; B60B 9/16; B60B 2360/104; B60B 2900/141; B60B 2360/102; B60B 2360/50; B60Y 2200/30

(57) ABSTRACT

The invention relates to a multi-part railway wheel for a railway vehicle, having a wheel tire, having an inner wheel part, having at least one elastic body arranged between the wheel tire and the inner wheel part, which body acts for electrical insulation, by way of which body the wheel tire is supported on the inner wheel part, and having a current bridge that is mounted on an outside end face of the railway wheel which bridge comprises a first contact element that consists of an electrically conductive material and lies against the wheel tire with a contact surface, a second contact element that consists of an electrically conductive material and lies against the inner wheel part with its contact surface and an electrical conductor that connects the contact elements. The inner wheel part consists of a light-metal material, at least in the region in which the contact element of the current bridge, which is assigned to the inner wheel part, lies against the inner wheel part with its contact surface. In order to prevent the risk of the formation of contact corrosion at a contact location, at which a contact element of the current bridge lies against a section of the inner wheel part that consists of a light-metal material, in the case of such a railway wheel, using simple means, the invention proposes forming the contact surface of the contact element that lies against the inner wheel part on a section of the contact element that consists of corrosion-resistant, electrically conductive steel material.

### CROSS-REFERENCE TO RELATED APPLICATIONS

This application is the United States national phase of International Application No. PCT/EP2020/063939 filed May 19, 2020, and claims priority to German Patent Application No. 10 2019 113 624.5 filed May 22, 2019, the disclosures of which are hereby incorporated by reference in their entirety.

### BACKGROUND OF THE INVENTION

### Field of the Invention

The invention relates to a railway wheel for a railway vehicle, which is composed of a wheel tire, an inner wheel part, and at least one elastic body that acts for electrical insulation, arranged between the wheel tire and the inner wheel part, by way of which body the wheel tire is supported on the inner wheel part. In order to produce an electrical connection between the inner wheel part and the wheel tire in spite of the electrical separation brought about by means of the elastic body, a current bridge is fastened to an outer end face of the railway wheel, which bridge comprises a first contact element that consists of an electrically conductive material and lies against the wheel tire with a contact surface, a second contact element that consists of an electrically conductive material and lies against the inner wheel part with its contact surface, and an electrical conductor that connects the contact elements. It is of particular significance for the invention, in this regard, that the inner wheel part consists of a light-metal material, at least in the region in which the contact element of the current bridge that is assigned to the inner wheel part lies against the inner wheel part with its contact surface.

### Description of Related Art

Multi-part railway wheels of the type in question here, also called “rubber-suspension railway wheels” in technical language, are preferably used in the case of railway vehicles of public local transport systems. As standard equipment, these wheels consist of an inner part, which is composed of a wheel hub, wheel disk, and wheel rim, which are each produced from a steel material having a suitable property profile, as well as of a wheel tire, which consists of wear-resistant steel. By means of the at least one elastic body arranged between the inner part and the wheel tire, the wheel tire is elastically suspension-mounted on the inner wheel part, so that high-frequency vibrations or other oscillations that are excited during traction operation as the result of rolling of the wheel tires on the rail are transmitted to the inner wheel part and the chassis of the railway vehicle connected with it in a damped manner, at most. As a rule, in this regard the wheel tire is supported on the inner wheel part not just by means of a single elastic body, but rather a plurality of such bodies is provided, which are arranged in the gap between the wheel tire and the inner wheel part, distributed about the axis of rotation of the railway wheel at uniform angular distances. In this manner, installation of such a railway wheel is simplified.

Due to the poor electrical conductivity of the rubber mixtures used for the elastic body or bodies, the wheel tire and the inner wheel part are electrically insulated from one another. In the case of electric trains used in local transport, however, the railway wheels frequently have not only the task of safely carrying the vehicle, guiding it on the track, and applying the drive moments and braking moments to the track, but also have the function of closing the power circuit with the traction current introduced by way of the catenary, and of conducting it to the rail as a return conductor.

Local transport railway vehicles have six to ten wheel sets, each having two railway wheels, depending on the vehicle concept, and are generally operated with direct current. The voltage typically amounts to 600-750 V. The total traction current lies in the range of 600-1000 A, depending on the engine power and the number of driven wheel sets. In the case of transmission of the traction current to the rail, ideally distributed uniformly to the railway wheels, typically a current of 75 A per wheel, for example, would flow during traction operation.

However, disadvantageous contact conditions between rail and wheel or between the individual parts of the wheel can lead to the result that the traction current taken up by the railway vehicle is not transmitted uniformly by all the wheels of the railway vehicle, but rather, in an extreme case, actually only by a single wheel. Such cases can occur after strong braking, for example, if there is braking sand lying on the rail, applied to increase friction, which hinders the flow of electrical current. In order to ensure, even in such situations, that sufficient current for drive of the vehicle can flow, design of the railway wheels usually takes place in such a manner that a current of at least 500 A per wheel can be constantly transmitted.

Additional demands on the electrical contact between rail and wheel, on the one hand, and the individual components of the railway wheel, on the other hand, result from the fact that in modern train control systems, railway wheels and rails are used for signal transmission from the railway vehicle to control devices on the track or to a central control center. Thus, for example, electrical switching pulses for switch and signal controls, track clear reporting systems, and the like are introduced into the rail by way of the electrical contact between wheel and rail, for example. In order to bring this about, a very low transition resistance has to be maintained on the path from the vehicle to the rail.

The maximum electrical transition resistances that a wheel set is allowed to have are established in EN 13260. In the new state of a wheel set, they amount to only 0.01 ohms at a test voltage of 1.8-2.0 V direct current. According to EN 15313, the transition resistance during operation is not allowed to exceed 0.1 ohms.

In the case of rubber-suspension railway wheels of the type in question here, this requirement can only be met in that the wheel tire is electrically connected with the inner wheel part by means of at least one current bridge that is separately mounted on the railway wheel. In this regard, the current bridge must be designed to be deformable, in such a manner that it does not influence the suspension properties of the wheel. If necessary, two or more current bridges are mounted on a railway wheel, so as to guarantee reliable transmission of the high currents or reliable signal transmission, for example.

The current bridges consist, in each instance, of very well electrically conductive stranded copper wires, which have a contact element in the form of a cable shoe at both ends, in each instance, in an embodiment that is currently usual, which shoe is structured in accordance with the DIN standard 46235. These contact elements are generally screwed onto one of the end faces of wheel tire and wheel rim.

An alternative is represented by what are called “inside current bridges.” These are current bridges that are integrated into the elastic elements of a railway wheel of the type in question here. They consist of contact plates composed of woven brass, which are held pressed against wheel tire and wheel rim due to the pressure preload of the rubber springs, and a conventional cable that connects the two contact plates. Such an embodiment of a current bridge is described, for example, in DE 2246580 B2.

A further possibility for bridging the insulation between wheel tire and inner wheel part formed by the elastic elements consists of arranging a contact sheet composed of tinned copper sheets between the elastic elements and the wheel tire, on the one hand, and the elastic elements and the inner wheel part, on the other hand, and of connecting the two contact sheets by means of a stranded copper wire, as described in DE 1044145 B.

In the case of the current bridges for railway wheels that are currently used in practice for transmission of traction currents and signal currents, the contact elements, by way of which the current bridge is electrically coupled with the inner wheel part and the wheel tire, are usually produced from copper material, due to its good electrical conductivity. To improve their oxidation resistance, the contact elements can be provided with a tin coating. The electrical conductor of the current bridge is usually a conventional copper cable, which is enclosed by an electrically insulating plastic sheathing that has a sufficient thickness.

The wheel tire of modern rubber-suspension railway wheels, as they are described in DE 196 33 597 C2, for example, typically consists of a high-strength steel that imparts sufficient resistance to abrasive friction wear to the wheel tire and, at the same time, enters into a friction pairing with the running surface of the rail, which pairing guarantees reliable transmission of the drive forces. In this regard, the current bridge sits directly on the steel of the wheel tires with its contact element. In the same manner, the other contact element sits on the outside of the assigned sections of the inner wheel part and, in this connection, has direct contact with the material from which this section has been produced.

This arrangement can lead to problems, in particular if the section of the inner wheel part in question consists of a light-metal material. Such problems result from the fact that the electrical connection is influenced not only by the stress caused by the current transmission itself, but in addition by surrounding media. Thus, the contact locations between the contact elements of the current bridge and the wheel tire, as well as the inner wheel part are subject to stress due to moisture, in particular sprayed water that occurs during rain or snow. This proves to be particularly critical during those seasons or under those climatic conditions during which moisture occurs at the same time in combination with salt or the like, as can happen during the winter, for example, or in locations close to an ocean. In this case, in particular, the moisture then acts like an electrolyte between the components that stand in electrical contact with one another.

It is known that in the case of components composed of metal materials having different positions in the electrochemical series, a difference in potential occurs if simultaneous wetting with an electrolyte takes place, and this difference leads to anodic dissolution of the “less precious” metal, in each instance. In the case of the current bridges of conventional rubber-suspension railway wheels, such a material pairing exists in the region of the contact between the wheel tire and inner wheel part, which consist of steel, and the contact elements of the current bridge, which consist of copper. If rain water, for example, acts as an electrolyte in the region of such a contact, and if the contact elements are tinned in the usual manner, for protection against corrosion, then the following electrochemical pairing is present:

[Fe(wheel tire)=−0.41 V]⇔[Sn(cable shoe coating)=−0.14 V]

In the case of direct contact between a non-tinned contact element consisting of copper material and the wheel tire consisting of steel, the following applies:

[Fe(wheel tire)=−0.41 V]⇔[Cu(copper cable shoe)=+0.34 V]

Accordingly, the voltage difference is 0.27 V if a tin layer is present, and 0.75 V in the case of direct contact of the copper of the contact element with the steel of the wheel tire.

Practical experience has shown that contact corrosion can occur if a difference in potential of min. 100 mV exists between the materials of which the components that come into contact with one another are produced. By means of the use of electrically conductive greases, such as, for example, greases based on an aluminum compound, entry of electrolytes can be extensively prevented in the contact region, so that in the case of a combination of a tinned copper cable shoe with the components of a multi-part railway wheel that consists of steel, experience has shown that no corrosion takes place.

The case is different if, as described in WO 2018/046745 A1, the component of the inner wheel part that comes into electrical contact with the contact element of a current bridge is produced from a light-metal material. Thus, when using a tinned contact element on a component of the inner wheel part, which component consists of an aluminum material, the following occurs:

[Al(wheel)=−1.66 V]⇔[Sn(cable shoe coating)=−0.14 V],

corresponding to a voltage difference of 1.52 V. If, in contrast, a non-tinned contact element of the current bridge is directly set against the section of the inner wheel part that consists of an aluminum material, the following applies:

[Al(wheel)=−1.66 V]⇔[Cu(copper cable shoe)=+0.34 V],

leading to a voltage difference of 2.0 V.

Here the differences in potential are therefore so great that during the minimum period of use of five years, on average, that is required also for hybrid railway wheels of the type in question here, contact corrosion will come about with a probability that borders on certainty. The accompanying damage, in particular in the region of the sections of the inner wheel part that consist of the corresponding light-metal material, would probably be so significant that a clear increase in the transition resistance will occur. Concomitantly, a strong temperature development must be expected due to the high currents that flow over the corresponding contact location during traction operation, as a result of which development the elastic elements, by way of which the wheel tire is supported on the inner wheel part, could be damaged.

Against this background, the invention was based on the task of creating a multi-part railway wheel, in the case of which the risk of the formation of contact corrosion at a contact location at which a contact element of the current bridge lies against a section of the inner wheel part that consists of a light-metal material is prevented, using simple means.

### SUMMARY OF THE INVENTION

The invention has accomplished this task by means of a railway wheel that possesses at least the characteristics as described herein.

Advantageous embodiments of the invention are indicated in the dependent claims, and will be explained in detail below, as will the general idea of the invention.

A multi-part railway wheel for a railway vehicle, according to the invention, therefore has, in agreement with the state of the art explained initially, a wheel tire, an inner wheel part, at least one elastic body that acts for electrical insulation and is arranged between the wheel tire and the inner wheel part, by way of which body the wheel tire is supported on the inner wheel part, and a current bridge that comprises a first contact element that consists of an electrically conductive material and lies against the wheel tire with a contact surface, a second contact element that consists of an electrically conductive material and lies against the inner wheel part with its contact surface, and an electrical conductor that connects the contact elements, wherein the inner wheel part consists of a light-metal material, at least in the region in which the contact element of the current bridge that is assigned to the inner wheel part lies against the inner wheel part with its contact surface.

According to the invention, the contact surface of the contact element that lies against the inner wheel part is configured on a section of the contact element that consists of a corrosion-resistant, electrically conductive steel material.

In that according to the invention, the contact surface is formed on a section of the contact element that consists of a corrosion-resistant steel, it is practically excluded that contact corrosion will come about in the region of contact between the section of the inner wheel part that consists of a light-metal material and the contact element of the corresponding current bridge that lies against this section. In this regard, the invention proceeds from the recognition that corrosion-resistant, rust-resistant steel is suitable for the purposes according to the invention, in spite of the relatively great difference in potential with reference to a light-metal material, in particular an aluminum material, since an oxidic passive layer forms on the surface of components that consist of such corrosion-resistant steel, which layer protects the steel material that lies underneath from corrosive attack. (It should be noted that the property designations “rust-resistant” and “corrosion-resistant” are used synonymously in the present text.)

In particular, corrosion-resistant, non-rusting steels having a chrome content of at least 16.5 wt.-% and a molybdenum content of at least 2.0 wt.-% are accordingly particularly suitable for the purposes according to the invention. Typical representatives of such steels are the steels contained in the steel-iron list under the material numbers 1.4401, 1.4404, 1.4571. In the case of such alloyed steels, a passive layer composed of chrome oxide forms on the contact surface with which the corresponding contact element lies against the assigned section of the inner wheel part that consists of light metal, due to the high chrome proportion, in each instance. This layer prevents electrolytic reactions between the contact surface and the surface of the light-metal section of the inner wheel part that lies against them from coming about. By alloying in Mo, in this regard the stainless steel becomes more resistant to corrosion in surroundings that contain chloride, as it occurs, for example, if salt is spread on the roads in winter in order to prevent ice formation.

The contact element assigned to the wheel tire can be produced, for example, in one piece from a copper material, such as, for example, the material that is known under the designation “Cu—HCP” and has been alloyed in accordance with DIN EN 13600. In contrast, the rust-resistant stainless steel known under the designation “V4A”, for example, is particularly suitable for the section of the contact element assigned to the inner wheel part, which section has the contact surface, whereas the other part of the contact element assigned to the inner wheel part can consist of the same highly conductive Cu material as the other contact element.

In accordance with an embodiment that is particularly important for practice and, at the same time, can be produced in a particularly cost-advantageous manner, in the case of a railway wheel according to the invention, the contact element that lies against the inner wheel part consists entirely of the corrosion-resistant, electrically conductive steel material. In this case, the contact element in question is produced, for example, in one piece from the corrosion-resistant steel, so that the section of the contact element that carries the contact surface is formed in one piece with the rest of the contact element. Practical tests have shown that even a contact element that consists entirely of the corrosion-resistant steel provided according to the invention has such a low electrical resistance that the electrical losses that occur above the current bridge provided with such a contact element are easily acceptable for practice.

If, in the case of a railway wheel according to the invention, a minimized electrical resistance is supposed to be guaranteed at the transition between the wheel tire and the section of the inner wheel part that consists of light-metal material, this can be achieved in that the contact element, which is assigned to the section of the inner wheel part that consists of a light-metal material, is not produced entirely from the corrosion-resistant steel. Instead, in this case the use of the rust-resistant steel is restricted just to the section on which the contact surface is formed, with which surface the contact element of the current bridge lies against the section of the inner wheel part that consists of light-metal material. In this way, the contact element assigned to the inner wheel part can be structured in such a manner that the total transition resistance remains minimal in spite of the use of the corrosion-resistant steel for its section that carries the contact surface. As the result of the measure that the contact element assigned to the inner wheel part must have at least two sections that consist of different materials, the invention has taken into consideration here that the total transition resistance of the current bridge provided on the outside of a rubber-suspension railway wheel, according to the invention, is determined not solely by means of the transition resistance between the inner wheel part and the assigned contact element, but rather, in particular, also by means of the transition resistance between the electrical conductor of the current bridge and the contact element.

In accordance with an advantageous embodiment of the invention, the contact element assigned to the inner wheel part is therefore divided at least into two sections, of which the one consists of a material that is optimized with regard to a maximum corrosion resistance in the region of the contact surface that comes into contact with the light-metal section of the inner wheel part, whereas the other section can be selected with regard to a minimal transition resistance between the contact element and the electrical conductor of the current bridge that is connected with it.

A multi-part rubber-suspension railway wheel according to the invention therefore has a wheel tire that typically consists of a steel material known from the state of the art for this purpose, whereas its inner wheel part is produced from a light construction material, in particular from an aluminum material also already proven in the state of the art for this purpose, wherein, for example, materials on a magnesium basis or titanium basis are also possible. Wheel tire and inner wheel part are connected by means of at least one electrically conductive current bridge, in which the connection locations to the wheel tire formed by the corresponding contact element can consist of an electrically highly conductive material, for example of copper or a copper alloy already known for this purpose, whereas the connection location to the inner wheel part is formed on a section of the corresponding contact element that consists of rust-resistant steel. Between the two connection locations, there is a stranded wire composed of electrically well conductive material, preferably of copper or a copper alloy already known for this purpose.

By means of the material mix provided for according to the invention, in the case of the current bridge of a railway wheel according to the invention, the result is achieved that the heating that unavoidably occurs during contact between the section of the contact element that consists of corrosion-resistant steel and the assigned contact surface of the section of the inner wheel part that consists of light-metal material, due to the good heat conductivity of the electrical conductors and the connection location that exists on the wheel tire, is conducted away into the wheel tire, and thereby overheating of the current bridge, in particular of its electrical conductor, is prevented. By means of the heat removal guaranteed in this way, the temperature-related increase in the transition resistance of the current bridge is furthermore also reduced. In this manner, it is guaranteed that the traction currents that occur during operation are permanently and reliably transmitted even under disadvantageous conditions between wheel and rail. The same holds true for the transmission of signal currents and the like.

In accordance with the above explanations, in the case of an embodiment of a railway wheel according to the invention that is particularly effective with regard to electrical conductivity, the contact element that lies against the inner wheel part with its contact surface is composed of at least two sections, of which the one is a connection section by way of which the contact element is connected with the electrical conductor, and of which the other section is a contact section that consists of the corrosion-resistant steel material, which section is connected with the connection section in an electrically conductive manner and is formed on the contact surface that lies against the inner wheel part.

For this purpose the connection section, for example, can be coated with the contact section on a side that is assigned to the inner wheel part. For this purpose the contact section can be configured in disk shape or plate shape, wherein in this case its thickness is typically 0.5-2.0 mm.

In this regard, optimally minimized transition resistances occur for the reasons already mentioned, if the connection section consists of a material that possesses greater electrical conductivity than that of the contact section that consists of the corrosion-resistant steel.

The material mix provided in this embodiment of the invention, of the contact element that lies against the inner wheel part, composed of highly corrosion-resistant steel in the region in which the contact surface is formed, on the one hand, and of highly conductive material in the region in which the connection with the electrical conductor of the current bridge takes place, on the other hand, can be implemented in any suitable manner. In this regard, the goal is minimized transition resistance between the materials that make contact with one another in each instance, on the one hand, and, on the other hand, a permanent reliable connection between the sections of the contact element is the goal.

For the production of a contact element structured in accordance with the invention, all methods are conceivable, for example, in which the rust-resistant steel material of the section provided with the contact surface is connected, with material fit, with the section of the contact element that is connected with the electrical conductor. These include all methods with which two separately prefabricated sections of a component can be connected with one another with material fit and electrical conduction, such as, for example, by means of welding or soldering. In the same way, the use of additive methods, such as deposition welding methods, powder metallurgy methods, 3D printing, and the like are conceivable.

Railway wheels of the multi-part type in question here, in which the connection section and the contact section are prefabricated separately from one another, from the material that is optimally suited for them, in each instance, and subsequently firmly connected with one another with shape fit and, if necessary, additionally with force fit, are particularly easy to produce and, at the same time, suitable for permanent use under rough ambient conditions. In the case of such a connection of the two parts that together form the corresponding contact element, preferably exclusively with shape fit, but in any case not with material fit, the contact elements can be produced in a particularly cost-advantageous manner, but at the same time can also be durably connected with one another so as to be particularly fit for use.

The shape-fit connection of the section of the corresponding contact element that is composed of the rust-resistant, corrosion-resistant material, on its section that consists of a different, preferably a better electrically conductive material, can be achieved in a simple manner, in this regard, in that a passage opening is formed in the connection section, and the contact element has a sleeve section configured in the manner of a sleeve, which sits in the passage opening of the connection section, through which section a fastening element, such as a screw, is passed for fastening the contact element of the current bridge that is assigned to the inner wheel part to the inner wheel part. In this embodiment, the sleeve section can be pressed into the opening of the connection section, so as to guarantee permanent, secure hold of the contact section that consists of the non-rusting material on the connection section. At the same time, undercuts can be provided in the region of the opening or of the edge region of the connection section that surrounds it, at which shape-fit clamping of the pressed material of the one section with the material of the other section of the contact element, in each instance, comes about.

Another possibility of a permanent connection of the contact section that consists of the rust-resistant material with the connection section of the contact element assigned to the inner wheel part consists in that the connection section is covered, at least in certain sections, by the contact section. Thus, the connection section can be configured in shoe shape, with a tongue-like projection, around which the contact section, which consists of a corrosion-resistant steel, is laid in the manner of a coat.

Fastening of the contact elements of the at least one current bridge provided in the case of a railway wheel according to the invention, to the wheel tire or inner wheel part of the railway wheel, preferably takes place, in each instance, in a known manner, by means of one screw fastening per connection location. The screws used for this purpose on the inner wheel part can consist, for example, of the material A4 that is standardized in DIN EN ISO 3506. To prevent incorrect installation, different thread diameters can be provided on the wheel tire and inner wheel part, and differently large related fastening bores can be provided on the contact elements of the current bridge.

Coupling of the electrical conductor to the corresponding contact element can take place by means of known mandrel pressing.

For further optimization of the protection against contact corrosion, at least the contact surface provided on the contact element assigned to the inner wheel part, which section is composed of rust-resistant steel, can be coated with a metallic corrosion protection layer that is electrically conductive. This layer can be formed, for example, in a conventional manner, from zinc or a zinc alloy. In this regard, the protective layer can extend over the entire contact element, but it should not cover the region in which the electrical conductor is connected with the contact element. Optimally, the additional corrosion protection layer is restricted to the region in which the electrical contact between the light-metal material of the assigned sections of the inner wheel part and the current bridge comes about.

As has been explained, in the case of a railway wheel according to the invention, at least the section against which the current bridge lies with its assigned contact element consists of a light-metal material. In this regard, the inner wheel part can be composed of multiple parts, but of these, at least the part on which the assigned contact element of the current bridge lies against the inner wheel part consists of a light-metal material. This, of course, includes the possibility that the inner wheel part consists, in its entirety, in each instance, of a suitable light-metal material that is known for this purpose from the state of the art, independent of whether it is produced in one piece or composed of at least two individual parts.

As has already been mentioned, an aluminum material known for the purpose is particularly suitable as a light-metal material of which at least the said section of the inner wheel part that comes into direct contact with the current bridge consists, but light-metal materials on a magnesium basis or titanium basis are also suitable.

### BRIEF DESCRIPTION OF THE DRAWINGS

In the following, the invention will be explained in greater detail using a drawing that represents an exemplary embodiment. The figures show, schematically in each instance:

FIG. 1 a cut-out of a multi-part railway wheel in a frontal view;

FIG. 2 the railway wheel according to FIG. 1 in a section along the section line X-X drawn in FIG. 1;

FIG. 3 a first variant of a current bridge in the non-installed state, in a side view;

FIG. 4 a cut-out of the current bridge according to FIG. 3 in an enlarged view, partly in section;

FIG. 5 the current bridge according to FIGS. 3 and 4 in the state preformed for installation;

FIG. 6 a second variant of a current bridge in the non-installed state, in a side view;

FIG. 7 a cut-out of the current bridge according to FIG. 6 in an enlarged view, partly in section;

FIG. 8 the current bridge according to FIGS. 6 and 7 in a frontal view;

FIG. 9 a cut-out of an alternative embodiment of a current bridge in a view corresponding to FIG. 7;

FIG. 10 the current bridge according to FIG. 9 in a frontal view.

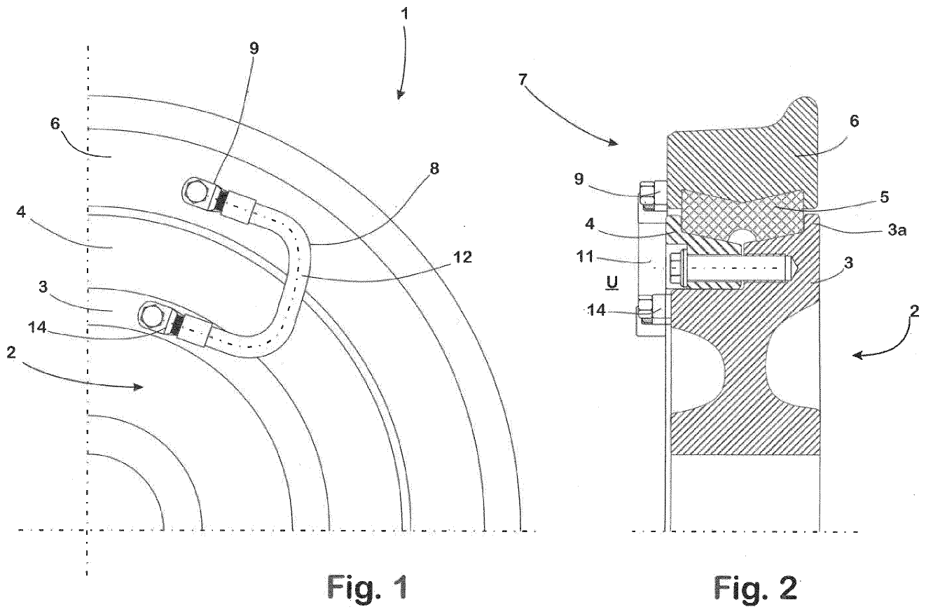

### DESCRIPTION OF THE INVENTION

The railway wheel 1, only a quarter of which is shown in FIG. 1, comprises an inner wheel part 2, which is composed, in a known manner, of a wheel rim 3 and a clamping ring 4. The wheel rim 3 is produced from an aluminum material that is known for this purpose, whereas the clamping ring 4 can consist of material having greater strength, which is also known for this purpose.

The railway wheel 1 furthermore comprises a ring-shaped elastic body 5, which is arranged on the outside circumference of the wheel rim 3 of the inner wheel part 2, a wheel tire 6 that sits on the elastic body 5 with its inside circumference surface and, in this manner, is elastically supported on the wheel rim 3 of the inner wheel part 2 in the radial direction of the railway wheel 1. In this regard, the clamping ring 4 is braced against the wheel rim 3 of the inner wheel part 2 and the elastic body 5, in the axial direction, from the direction of an end face 7 of the railway wheel 1, by means of tensioning screws. Since the elastic body 5 is simultaneously supported on its side that lies opposite the clamping ring 4, on a circumferential step 3a of the wheel rim 3 of the inner wheel part 2, the pressure between the elastic body 5, on the one hand, and the wheel tire 6 as well as the wheel rim 3 of the inner wheel part 2, on the other hand, increases with increasing axial bracing of the clamping ring 4.

A current bridge 8 is fastened on at the end face 7 of the railway wheel 1, which bridge electrically connects the wheel tire 6, which consists of a suitable high-strength steel material, with the wheel rim 3 of the inner wheel part 2, which consists of an aluminum material.

For this purpose, the current bridge 8 comprises a first contact element 9, which consists of a copper material known for this purpose, which element is configured, in a conventional manner, in one piece, in the manner of a standard cable shoe, and has a contact surface 10 on its flat side, with which it lies against the assigned end face of the wheel tire 6. A standard screw is passed through the passage opening introduced into the contact element 9, in a known manner, which screw is screwed into a threaded bore formed in the wheel tire 6, which bore cannot be seen here.

The first contact element 9 of the current bridge 8 is firmly coupled, in a known manner and in an electrically conductive manner, with the end of a stranded copper wire 12 that serves as an electrical conductor 11 of the current bridge 8, which wire is shielded with regard to the surroundings U of the current bridge 8, with a sufficiently thick insulation layer 13.

A second contact element 14 is connected at the other end of the stranded copper wire 12 of the electrical conductor 11, by way of which wire the electrical contact to the wheel rim 3 of the inner wheel part 2 is produced. According to the invention, this second contact element 14, which is assigned to the inner wheel part 2, also has a connection section 15 that corresponds to a conventional, standardized cable shoe, in terms of its outer and functional design, which section possesses a connection region 16 against which the assigned end of the stranded copper wire 12 lies, on the one hand, and, on the other hand, a tongue-like projection 17 that is directed away from the stranded copper wire 12. A passage opening that leads from its top side to its underside is formed in this projection, through which opening a fastening screw for fastening the second contact element 14 to the inner wheel part 2 can be passed during use.

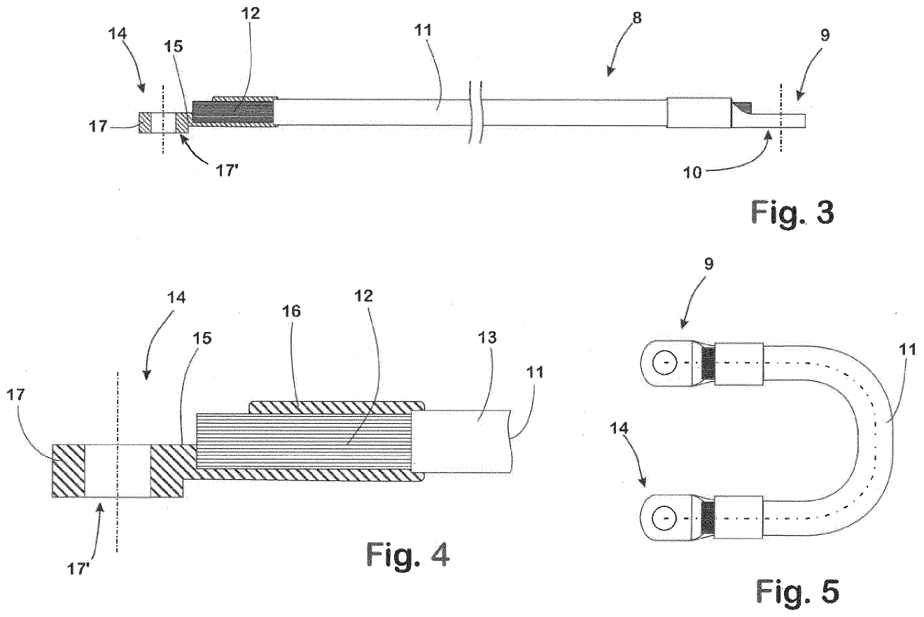

In the embodiment of the invention shown in FIGS. 3 and 4, the second contact element 14 that is assigned to the inner wheel part 2 is produced in one piece, for example by means of forging, from a rust-resistant steel. In this regard, the projection 17 forms the section that consists of the non-rusting material, with the planar contact surface formed on its underside, on which, according to the invention, the contact surface 17′ is formed, with which the second contact element 14 lies against the assigned surface of the section of the inner wheel part 2 consisting of light-metal material during use.

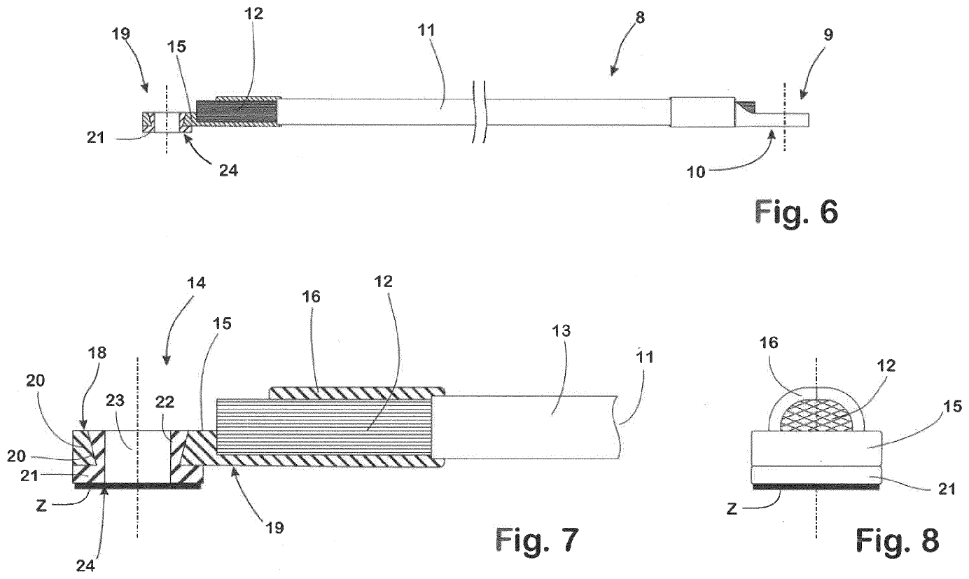

In the variants of the current bridge 8 shown in FIGS. 5-10, in contrast, the second contact element 14, which is assigned to the inner wheel part 2, is composed of two sections. Thus, here the projection 17 of the second contact element 14, like the first contact element 9, consists of an electrically highly conductive copper material.

In the variant shown in FIGS. 5-8, a passage opening 20 is formed in the projection 17 of the second contact element 14, also leading from its top side 18 to its underside 19, which is configured to be planar, which opening widens in funnel shape, proceeding from its mouth region that is assigned to the underside 19, in the direction of the top side 18 of the projection 17.

A contact section 21, produced separately from the connection section 15, from a rust-resistant steel material, lies against the underside 19. In this regard, the contact section 21 is formed in the manner of a washer disk or washer plate, with a thickness of 1 mm, for example, in such a manner that it completely covers the underside 19 of the projection 17 of the connection section 15, which underside is configured to be planar.

On its top side assigned to the underside 19 of the connection section 15, the contact section 21 carries a sleeve section 22 produced in one piece with it, which section has been pushed into the passage opening 20 of the connection section 15 and subsequently pressed into the passage opening 20 in such a manner that the passage opening 20 is filled with material of the contact section 21, and only the cylindrical passage opening 23, which is surrounded by the sleeve section 22, remains. Due to the pressing, on the one hand, and the undercut formed in the region of the passage opening 20 of the connection section 15, which widens in funnel shape, on the other hand, the contact section 21 is held firmly on the connection section 15, with shape fit and force fit, so that an electrically perfect connection is produced between the sections 15 and 21 of the contact element 14.

On the free underside of its contact section 21 that consists of corrosion-resistant steel material, the contact element 14 has a contact surface 24, with which it lies flat, during use, against the assigned end face 7 of the wheel rim 3 of the railway wheel 1, which consists of an aluminum material.

A conventional, standardized screw is inserted through the passage opening 23 of the contact section 14 in the finished, assembled state, which screw is screwed into a threaded bore provided for fixation of the contact element 14 on the assigned contact surface, on the end face 7 of the wheel rim 3 of the inner wheel part 2, which bore cannot be seen here.

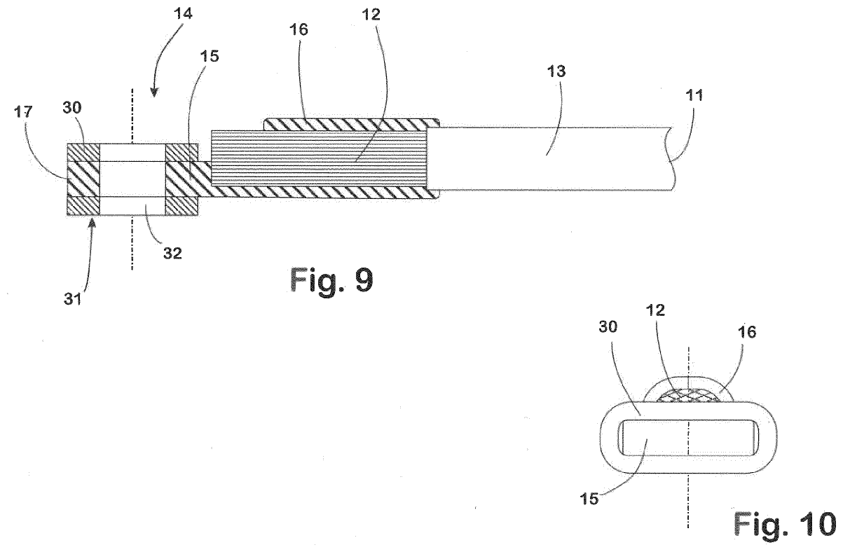

In the variant shown in FIGS. 9 and 10, in contrast to the embodiment shown in FIGS. 5-8, a contact section 30 that was also separately prefabricated, but here formed in the manner of a sleeve, has been pushed on around the projection 17 of the second contact element 14 of the current bridge 8 assigned to the wheel rim 3 of the inner wheel part 2, and pressed on in such a manner that during use, on the one hand, a planar contact surface 31 is also present on the underside of the contact element 14, with which the contact element 14 lies flat against the assigned end face 7 of the wheel rim 3 of the railway wheel 1 that consists of aluminum material, and on the other hand the projection 17 is covered by the contact section 30.

A passage opening 32 passes through the contact section 30 and the projection 17. A conventional, standardized screw is inserted through the passage opening 32, which screw is screwed into a threaded bore provided for fixation of the contact element 14 on the assigned contact surface on the end face 7 of the wheel rim 3 of the inner wheel part 2, which bore cannot be seen here.

For optimization of the protection against the formation of corrosion in the region in which the corresponding first contact element 9, with its contact surface 10, and the corresponding second contact element 14, with its corresponding contact surface 17′, 24, 31, lies flat against the assigned end face 7, the contact surfaces 10, 17′, 24, 31, as indicated in FIGS. 7 and 8, in each instance, can be covered with a zinc coating Z.

### REFERENCE SYMBOLS

1 railway wheel
2 inner wheel part
3 wheel rim (region against which the contact element 14 lies)
3a circumferential step of the wheel rim 3
4 clamping ring
5 elastic body
6 wheel tire
7 end face of the railway wheel 1, of its wheel tire 6, as well as of its wheel rim 3
8 current bridge
9 contact element of the current bridge 8 assigned to the wheel tire 6
10 contact surface of the contact element 9
11 electrical conductor of the current bridge 8
12 stranded copper wire of the electrical conductor 11
13 insulation layer of the electrical conductor 11
14 second contact element assigned to the wheel rim 3 of the inner wheel part 2
15 connection section of the contact element 14
16 connector region of the connection section 15
17 projection of the connection section 15
17′ contact surface of the contact element 14 (FIGS. 3, 4)
18 top side of the projection 17
19 underside of the projection 17
20 funnel-shaped passage opening of the projection 17
21 contact section of the contact element 14
22 sleeve section of the contact section 21
23 passage opening of the contact element 14
24 contact surface of the contact element 14 (FIGS. 5-8)
30 contact section
31 contact surface of the contact section 30 (FIGS. 9, 10)
32 passage opening
U surroundings of the current bridge 8
Z zinc coating

1. A multi-part railway wheel for a railway vehicle, having a wheel tire, having an inner wheel part, having at least one elastic body arranged between the wheel tire and the inner wheel part, which body acts for electrical insulation, by way of which body the wheel tire is supported on the inner wheel part and having a current bridge mounted on an outer end face of the railway wheel, which bridge comprises a first contact element that consists of an electrically conductive material and lies against the wheel tire with a contact surface, a second contact element that consists of an electrically conductive material and lies against the inner wheel part its contact surface, and an electrical conductor that connects the contact elements wherein the inner wheel part consists of a light-metal material at least in the region in which the contact element of the current bridge that is assigned to the inner wheel part lies against the inner wheel part with its contact surface wherein the contact surface of the contact element that lies against the inner wheel part is formed on a section of the contact element, which section consists of a corrosion-resistant, electrically conductive steel material.

2. The railway wheel according to claim 1, wherein the contact element that lies against the inner wheel part consists entirely of the corrosion-resistant, electrically conductive steel material.

3. The railway wheel according to claim 1, wherein the contact element that lies against the inner wheel part with its contact surface composed of at least two sections, of which the one section is a connection section, by way of which the contact element is connected with the electrical conductor and of which the other section is a contact section consisting of the corrosion-resistant steel material, which section is connected with the connection section in an electrically conductive manner, and on which section the contact surface that lies against the inner wheel part is formed.

4. The railway wheel according to claim 3, wherein the connection section consists of a material that possesses greater electrical conductivity than the contact section that consists of the corrosion-resistant steel.

5. The railway wheel according to claim 3, wherein the connection section coated with the contact section on a side assigned to the inner wheel part.

6. The railway wheel according to claim 3, where the connection section the contact section are firmly connected with one another by means of shape fit, which is optionally supplemented with force fit.

7. The railway wheel according to claim 3, wherein a passage opening is formed in the connection section, and that the contact section has a sleeve section formed in the manner of a sleeve, which sits in the passage opening of the connection section, through which section a fastening element is passed, for fastening the contact element of the current bridge that is assigned to the inner wheel part to the inner wheel part.

8. The railway wheel according to claim 3, wherein the contact section encases the connection section at least in certain sections.

9. The railway wheel according to claim 3, wherein the connection section consists of a copper material.

10. The railway wheel according to claim 1, wherein the corrosion-resistant steel of which the section of the contact element of the current bridge consists, which section has the contact surface assigned to the inner wheel part, has a Cr content of at least 16.5 wt.-% and a Mo content of at least 2.0 wt.-%.

11. The railway wheel according to claim 1, wherein the contact element that lies against the wheel tire consists, in its entirety, of a material that possesses greater electrical conductivity than the rust-resistant steel of which the section of the contact element assigned to the inner wheel part consists, which section has the contact surface.

12. The railway wheel according to claim 1, wherein at least the contact element that lies against the inner wheel part is coated, at least in the region of its contact surface, with an electrically conductive coating that protects against corrosion.

13. The railway wheel according to claim 12, wherein the coating consists of a metallic material.

14. The railway wheel according to claim 13, wherein the coating formed from a zinc material.

15. The railway wheel according to claim 1, wherein the inner wheel part consists of an aluminum material, a magnesium material or a titanium material in the region in which the assigned contact element of the current bridge against it.

16. The railway wheel according to claim 1, wherein the inner wheel part is composed of multiple parts, of which at least the part at which the assigned contact element of the current bridge lies against the inner wheel part consists of a light-metal material.
